(19) United States
(12) Patent Application Publication
(10) Pub. No.: US 2021/0087033 A1
(43) Pub. Date: Mar. 25, 2021

(54) MACHINE LEARNING METHOD, FORKLIFT CONTROL METHOD, AND MACHINE LEARNING APPARATUS

(71) Applicants: HITACHI, LTD., Tokyo (JP); HITACHI SOLUTIONS, LTD., Tokyo (JP)

(72) Inventors: Nobutaka KIMURA, Tokyo (JP); Kouichi SETO, Tokyo (JP); Yutaka IWAMOTO, Tokyo (JP); Hidekazu ITO, Tokyo (JP); Koji ARA, Tokyo (JP)

(73) Assignees: HITACHI, LTD., Tokyo (JP); HITACHI SOLUTIONS, LTD., Tokyo (JP)

(21) Appl. No.: 17/007,504

(22) Filed: Aug. 31, 2020

(30) Foreign Application Priority Data
Sep. 20, 2019 (JP) 2019-171829

(51) Int. Cl. B66F 9/075; G05D 1/02; G06N 20/00

(52) U.S. Cl. CPC B66F 9/07581; B66F 9/0755; G05D 2201/0216; G06N 20/00; G05D 1/0221

(57) ABSTRACT

A forklift which carries a cargo is includes a machine learning apparatus which executes a procedure of: accepting input of learning data of a first category group and evaluation data of a second category group; extracting the learning data of at least one category from the first category group and calculating parameters of the estimation models for controlling the forklift by using the extracted learning data; extracting the evaluation data of at least one category from the second category group and evaluating the estimation models, for which the parameters are calculated, by using the extracted evaluation data; and outputting an estimation model M whose data evaluation result is equal to or larger than a specified threshold value, from among the estimation models for which the parameters are calculated, and a category of the evaluation data used for the evaluation of the estimation model M.

### TECHNICAL FIELD

The present invention relates to a machine learning method, a forklift control method, and a machine learning apparatus and is suited for use in a machine learning method, forklift control method, and machine learning apparatus for learning estimation models for controlling a forklift.

### BACKGROUND ART

Conventionally, a haulage vehicle such as a forklift is used to perform cargo carrying work inside a warehouse. For example, the forklift carries a cargo by a sequence of work to insert and lift (or pick) top ends of its fork into an opening(s) in a pallet loaded with the cargo and move the cargo mounted on the fork to a specified position and put (or place) it down there. The specified position to moves up and down the pallet is, for example, a luggage rack or an autorator. In recent years, introduction of unmanned forklifts which can be operated unmanned has been being promoted.

Regarding the cargo carrying work which uses the above-described forklift, it is important to recognize an object of the work (such as the opening(s) in the pallet) accurately in order to operate the fork appropriately; and, for that purpose, it is widely conducted to install a sensor such as a camera on a front face of the forklift and analyze images of its sensing data. Furthermore, the use of machine learning has been being promoted in order to enhance the accuracy of the image analysis.

For example, PTL 1 discloses a control apparatus that controls a robot by calculating a parameter for image processing by using machine learning and detecting an object by the image processing based on this parameter. Furthermore, for example, PTL 2 discloses a machine learning apparatus that: performs machine learning by using learning data which associates a hold point of an object held by a robot arm with track plan easiness, which quantifies easiness of a track plan to plan the track to the hold point of the robot arm, with regard to picking work by the robot arm; and calculates a predicted position of the hold point and a predicted value of the track plan easiness.

### CITATION LIST

### Patent Literature

PTL 1: Japanese Patent Application Laid-Open (Kokai) Publication No. 2018-126799

PTL 2: Japanese Patent Application Laid-Open (Kokai) Publication No. 2017-110872

### SUMMARY OF THE INVENTION

### Problems to be Solved by the Invention

However, when the above-described conventional technology is used to perform the machine learning in order to control, for example, a haulage vehicle and if the collected learning data is not sufficient, there is a fear that sufficient accuracy for actual operation may not be achieved even if the machine learning is performed. Specifically speaking, if significantly different data coexist in the collected learning data with respect to various operation scenes such as object measurement directions and brightness of a work place, there is a problem of increase of the learning data which are required to achieve the sufficient accuracy. Then, the technology disclosed in PTL 1 or PTL 2 above does not present any sufficient solution for this problem.

Specifically, regarding the conventional machine learning for controlling the haulage vehicle or the like, the learning data which would achieve the necessary accuracy for the actual operation with respect to various operation scenes have been required; and particularly in a case of a haulage vehicle which operates unmanned like an unmanned forklift, it has been impossible to use such a haulage vehicle for the actual operation until the sufficient accuracy is satisfied with respect to all these operation scenes in consideration of safety. As a result, an enormous amount of learning data needs to be collected until it becomes possible to start the actual operation, thereby resulting in a problem of lengthening of a preparation period until the actual operation.

The present invention was devised in consideration of the above-described circumstances and aims at proposing a machine learning method, forklift control method, and machine learning apparatus capable of making a haulage vehicle (such as a forklift) actually operate at early timing while limiting operation scenes.

### Means to Solve the Problems

In order to solve the above-described problems, provided according to an aspect of the present invention is a machine learning method for learning estimation models for controlling a forklift, wherein the machine learning method executes: step 1 of accepting input of learning data of a first category group and evaluation data of a second category group; step 2 of extracting the learning data of at least one category from the first category group and calculating parameters of the estimation models for controlling the forklift by using the extracted learning data; step 3 of extracting the evaluation data of at least one category from the second category group and evaluating the estimation models, for which the parameters are calculated in the step 2, by using the extracted evaluation data; and step 4 of outputting the estimation models, each of which has an evaluation result of the step 3 that is equal to or larger than a specified threshold value, from among the estimation models for which the parameters are calculated in the step 2, and a category of the evaluation data used for the evaluation of each above-mentioned estimation model in the step 3.

Furthermore, in order to solve the above-described problems, provided according to another aspect of the present invention is a forklift control method for executing an input step, an estimation step, and a control step, which will be described below in detail. Under this circumstance, in the input step, sensing data by a sensor which is installed at the forklift is accepted as input. Furthermore, in the estimation step, the sensing data accepted in the input step is analyzed by using a first estimation model obtained by executing the following step 1 to step 5, and an estimation result obtained by the analysis is output; step 1 of accepting input of learning data of a first category group and evaluation data of a second category group; step 2 of extracting the learning data of at least one category from the first category group and calculating parameters of estimation models for controlling the forklift by using the extracted learning data; step 3 of extracting the evaluation data of at least one category from the second category group and evaluating the estimation models, for which the parameters are calculated in the step 2, by using the extracted evaluation data; step 4 of outputting the estimation models, each of which has an evaluation result of the step 3 that is equal to or larger than a specified threshold value, from among the estimation models for which the parameters are calculated in the step 2, and a category of the evaluation data used for the evaluation of each above-mentioned estimation model in the step 3; and step 5 of extracting the first estimation model from among the estimation models output in the step 4 on the basis of operation frequency of the category of the evaluation data output in the step 4. Then, in the control step, the forklift is controlled based on a result of the estimation step.

Furthermore, in order to solve the above-described problems, provided according to another aspect of the present invention is a machine learning apparatus for learning estimation models for controlling a forklift, wherein the machine learning apparatus includes: a data acquisition unit that accepts input of learning data of a first category group and evaluation data of a second category group; a parameter calculation unit that extracts the learning data of at least one category from the first category group and calculates parameters of the estimation models for controlling the forklift by using the extracted learning data; an estimation model evaluation unit that extracts the evaluation data of at least one category from the second category group and evaluates the estimation models, for which the parameters are calculated by the parameter calculation unit, by using the extracted evaluation data; and an estimation model operational evaluation category output unit that outputs the estimation models, each of which has an evaluation result by the estimation models evaluation unit that is equal to or larger than a specified threshold value, from among the estimation models for which the parameters are calculated by the parameter calculation unit, and a category of the evaluation data used for the evaluation of each above-mentioned estimation model by the estimation model evaluation unit.

### Advantageous Effects of the Invention

According to the present invention, a haulage vehicle (such as a forklift) can be made to actually operate at early timing while limiting operation scenes.

### BRIEF DESCRIPTION OF DRAWINGS

FIG. 1 is a block diagram illustrating a functional configuration example of the entire system including a machine learning apparatus according to one embodiment of the present invention;

FIG. 2 is a diagram illustrating a display screen example of a teaching IF;

FIG. 3A is a diagram illustrating a data structure example of learning data stored in a learning data storage unit;

FIG. 3B is a diagram illustrating a data structure example of evaluation data stored in an evaluation data storage unit;

FIG. 3C is a diagram illustrating a data structure example of second category information stored in a second category information storage unit;

FIG. 4 is a flowchart (1) illustrating a processing sequence example of estimation model learning processing;

FIG. 5 is a flowchart (2) illustrating a processing sequence example of the estimation model learning processing;

FIG. 6 is a flowchart illustrating a processing sequence example of first forklift control processing;

FIG. 7 is a flowchart illustrating a processing sequence example of fourth forklift control processing; and

FIG. 8 is a diagram for explaining the relationship between estimation models and second category ID's in the evaluation results R of the estimation models.

### DESCRIPTION OF EMBODIMENTS

One embodiment of the present invention will be described below in detail with reference to the drawings.

### (1) Configuration

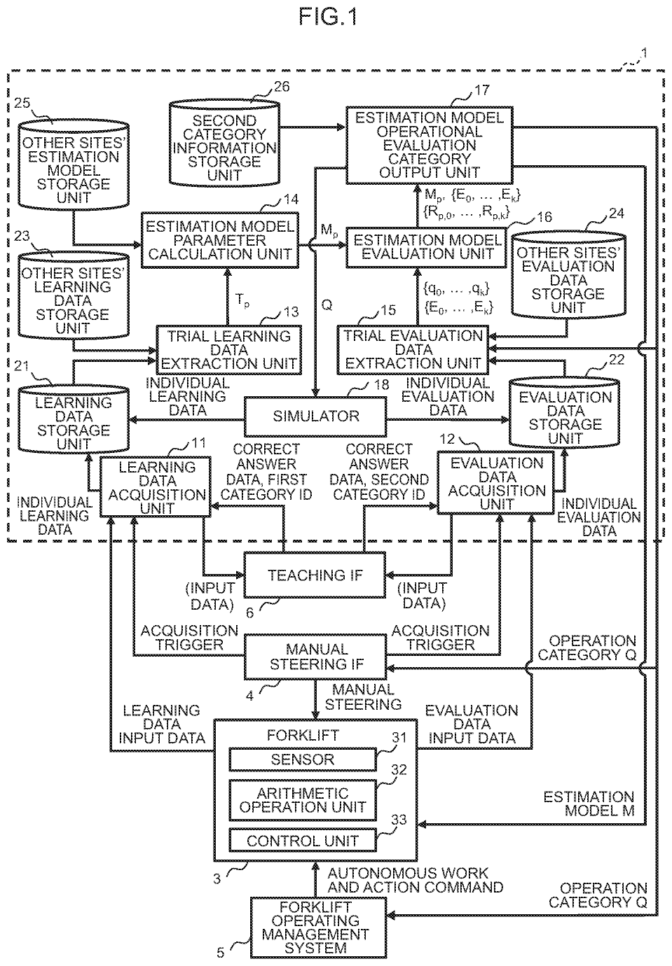

FIG. 1 is a block diagram illustrating a functional configuration example of the entire system including a machine learning apparatus according to one embodiment of the present invention. In FIG. 1, a solid line with an arrow represents a flow of data. As illustrated in FIG. 1, a machine learning apparatus 1 according to this embodiment is coupled to a forklift 3, a manual operation interface (IF) 4, a forklift operating management system 5, and a teaching interface (IF) 6 so that they can communicate with each other.

The machine learning apparatus 1 is an apparatus for learning estimation models for controlling the forklift 3 and is a computer configured by including processors such as a CPU (Central Processing Unit) and a GPU (Graphics Processing Unit), and a memory for storing programs and data. The internal configuration of the machine learning apparatus 1 will be described later and each functional unit is implemented by a processor reading and executing a program stored in the memory.

As the details will be described later, regarding work of the forklift 3 to carry a pallet loaded with a cargo, the machine learning apparatus 1 repeatedly executes processing for learning estimation models for recognizing the position of a pallet from sensing data by using collected learning data, and evaluating the learned estimation models by using evaluation data, so that the evaluation result (recognition accuracy) achieves the accuracy required for actual operation and the machine learning apparatus 1 outputs an estimation model with the highest operation frequency and its operation scene.

The forklift 3 is a forklift which can be driven unmanned. As the details will be described later with regard to forklift control processing, the forklift 3 can automatically perform carrying actions in accordance with an autonomous work and action command from the forklift operating management system 5 in the operation scene regarding which the evaluation result (recognition accuracy) to achieve the accuracy required for the actual operation is obtained. Furthermore, in an operation scene regarding which the evaluation result to achieve the accuracy required for the actual operation is not obtained (non-operation scene), the forklift 3 can manually perform the carrying actions in accordance with a manual steering command from the manual operation IF 4. The forklift 3 includes a sensor 31, an arithmetic operation unit 32, and a control unit 33.

The sensor 31 is a camera installed on, for example, the front side of the forklift 3 and acquires sensing data around an opening(s) of a pallet, into which the fork is to be inserted, by capturing images of a space in front of the forklift 3. The sensing data (for example, image data captured by the camera) is used for image analysis by the arithmetic operation unit 32 and also transmitted as input data (input data for learning data and input data for evaluation data) to the learning data acquisition unit 11 or the evaluation data acquisition unit 12 for the machine learning apparatus 1 at specified timing. Specific examples of the timing to acquire the sensing data by the learning data acquisition unit 11 or the evaluation data acquisition unit 12 include timing based on an acquisition trigger issued from the manual steering IF 4 and also timing based on data acquisition information included in an instruction from the forklift operating management system 5.

The arithmetic operation unit 32 is an arithmetic operation apparatus having a function that executes image processing on the sensing data acquired by the sensor 31. Specifically speaking, the arithmetic operation unit 32 analyzes the sensing data acquired by the sensor 31 by using the estimation models evaluated and output by the machine learning apparatus 1 and estimates a specified object (for example, a pallet).

The control unit 33 is a control apparatus having a function that controls all actions of the forklift 3. As the details will be described later, for example, when causing the forklift 3 to perform actions in accordance with an autonomous work and action command from the forklift operating management system 5, the control unit 33 controls the actions of the forklift 3 on the basis of the specified object estimation result calculated by the arithmetic operation unit 32. Furthermore, when receiving a manual steering command from the manual steering IF 4, the control unit 33 controls the actions of the forklift 3 in accordance with that command.

The manual operation IF 4 is an interface for manual operation of the forklift 3. The manual operation IF 4 may be a controller mounted in the forklift 3 or a remote controller for remote control of the forklift 3.

The forklift operating management system 5 can utilize a conventionally known vehicle operating management system and performs operating management to manage which carrying work should be executed by which vehicle among a plurality of forklifts 3 and other haulage vehicles at which timing.

The forklift operating management system 5 can output the autonomous work and action command to instruct the forklift 3 to execute actions by autonomous work. The forklift operating management system 5 issues an instruction, as the autonomous work and action command, to designate, for example, a movement passage (via-point(s)) of the forklift 3, the height of the fork (which may be the sensor 31), and the work content (such as picking or placement). Furthermore, by assigning instruction information about the acquisition of the sensing data (data acquisition information) to the above-mentioned via-point instruction, it is possible to issue the instruction to acquire the sensing data by the sensor 31 at a specified acquisition place. Specifically speaking, the data acquisition information can include, for example, the acquisition place of the sensing data, the intended use of the acquired sensing data (for learning and for evaluation), and their category ID (particularly, a second category ID of the evaluation data).

The teaching IF 6 is an interface for displaying the input data and making a user decide correct answer data and a category ID corresponding to the input data and is, for example, generally a general purpose computer having output devices such as a display and input devices such as a keyboard and a mouse.

Under this circumstance, the input data is the sensing data acquired by the forklift 3 (the sensor 31) for the learning data or for the evaluation data. Furthermore, the correct answer data is data indicating correct recognition result of the specified object (for example, the pallet) with respect to the input data and the category ID is an identifier indicating a category to which a set of the input data and the correct answer data belongs. In this embodiment, the first category and the second category are indicated as categories and the details of these categories will be described later.

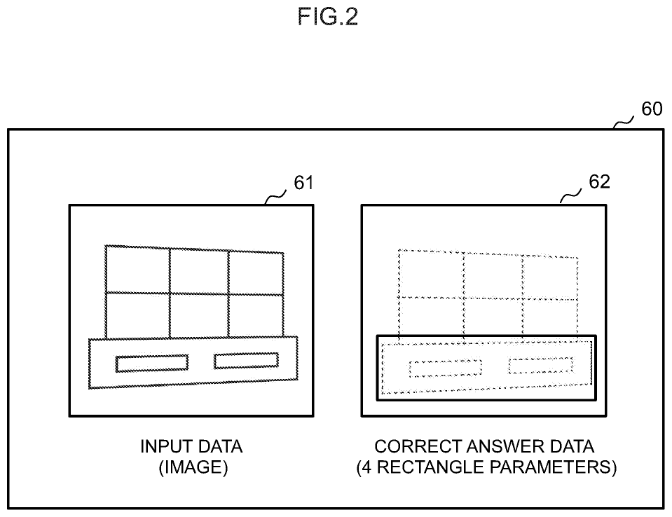

FIG. 2 is a diagram illustrating a display screen example of the teaching IF. A display screen 60 illustrated in FIG. 2 has: an area 61 in which the input data is displayed; and an area 62 in which the correct answer data is displayed. The teaching IF 6 executes processing on the display screen 60 according to the following flow.

Firstly, the teaching IF 6 receives the sensing data acquired by the forklift 3 as the input data (the input data for the learning data or the input data for the evaluation data) from the machine learning apparatus 1 (the learning data acquisition unit 11 or the evaluation data acquisition unit 12) and displays it in the area 61. Incidentally, when the input data is in a format other than the image data, visualization processing may be executed on the input data and the obtained data may be then displayed in the area 61. Furthermore, the teaching IF 6 also displays an image of the input data in the area 62. In a case of FIG. 2, outline extraction processing is executed on the image of the input data and the outlines of the pallet and cargo are displayed with broken lines in the area 62. Next, the user performs an input operation to surround the correct position of the pallet (a rectangular part indicated with a solid line) with respect to the area 62 of this display screen 60 and the result is decided as the correct answer data. Then, the user decides to which category the decided correct answer data belongs by performing a specified input operation (illustration in the drawing is omitted). Then, lastly, the teaching IF 6 transmits the set of the correct answer data and the category ID, which have been decided on the display screen 60, to the machine learning apparatus 1 (the learning data acquisition unit 11 or the evaluation data acquisition unit 12). Incidentally, the format of the correct answer data is not limited to any specific format. For example, the correct answer data is decided with the rectangle as illustrated in the area 62 in FIG. 2.

The internal configuration of the machine learning apparatus 1 will be explained.

As illustrated in FIG. 1, the machine learning apparatus 1 includes, as functional units, the learning data acquisition unit 11, the evaluation data acquisition unit 12, a trial learning data extraction unit 13, an estimation model parameter calculation unit 14, a trial evaluation data extraction unit 15, an estimation model evaluation unit 16, an estimation model operational evaluation category output unit 17, and a simulator 18. Specific processing by each functional unit will be explained in detail in the explanation about estimation model learning processing described later.

Furthermore, the machine learning apparatus 1 includes, as a storage unit for storing data, a learning data storage unit 21, an evaluation data storage unit 22, an other sites' learning data storage unit(s) 23, an other sites' evaluation data storage unit(s) 24, an other sites' estimation model storage unit(s) 25, and a second category information storage unit 26. Each storage unit is implemented by a storage apparatus (which may be external storage areas like databases and cloud with which the machine learning apparatus 1 can communicate) for the machine learning apparatus 1.

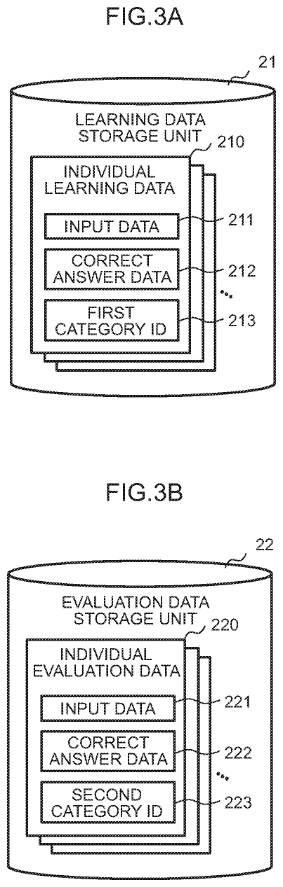

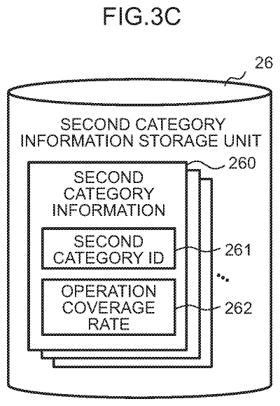

FIG. 3A illustrates a data structure example of the learning data (individual learning data 210) stored in the learning data storage unit 21; FIG. 3B illustrates a data structure example of the evaluation data (individual evaluation data 220) stored in the evaluation data storage unit 22; and FIG. 3C illustrates a data structure example of second category information 260 stored in the second category information storage unit 26.

Firstly, an explanation will be provided regarding categories. In this embodiment, the learning data is prepared by being divided into a plurality of categories (first categories) and all the plurality of first categories will be referred to as a first category group. Furthermore, the evaluation data is prepared by being divided into a plurality of categories (second categories) and all the plurality of second categories will be referred to as a second category group.

The first categories and the second categories can be divided based on, for example, “operation scenes” regarding which various conditions and states of the operation of the forklift 3 are classified. Specific examples of classification references of the operation scenes (categories) for the pallet recognition include a camera image capture object, an image capture direction, and an image capture distance, a work area of the forklift, time of day for work, pallet types, or loading conditions. A supplementary explanation will be provided regarding each specific example. When the camera image capture direction (left, center, or right) or the image capture distance (far or close) varies, the shape of the pallet in captured image data (input data) changes significantly. Furthermore, when the time of day for work (morning, noon, or night) varies, differences in pallet recognition performance arise depending on brightness. Since these differences also depend on a sunlight radiation amount from, for example, windows of a warehouse, the weather may be used as the classification references. Furthermore, when the pallet type (such as colors and materials) varies, there is a possibility that the position of an opening(s) in the pallet may change. Furthermore, when the loading condition (with or without the cargo or with or without wrapping) varies, the type of the cargo which is an object to be carried may possibly be different.

Incidentally, in this embodiment, divisions of the first categories, the second categories, and the operation scenes do not necessarily have to completely match each other. However, when they are divided separately differently and the machine learning apparatus 1 executes processing in consideration of mutual relationship, it is necessary to separately retain, for example, information which defines the correspondence relationship between both the categories and the operation scenes.

Referring to FIG. 3A, the learning data storage unit 20 stores a plurality of pieces of individual learning data 210 as the learning data. Each piece of individual learning data 210 includes input data 211, correct answer data 212, and a first category ID 213.

The input data 211 is the sensing data (input data for the learning data) acquired by the forklift 3 for the learning data. The correct answer data 212 is correct answer data of the input data 211. The first category ID 213 is an identifier indicating the first category to which the individual learning data 210 belongs.

As illustrated in FIG. 1, the learning-data input data which becomes the input data 211 is input from the forklift 3 to the learning data acquisition unit 11. Furthermore, as explained with reference to FIG. 2, this input data 211 is transmitted to the teaching IF 6 and displayed; and as the user decides the correct answer data 212 and the first category ID 213 of the input data 211 with respect to this display, the correct answer data 212 and the first category ID 213 are input from the teaching IF 6 to the learning data acquisition unit 11. As a result, the learning data acquisition unit 11 can acquire the input data 211, the correct answer data 212, and the first category ID 213; and the individual learning data 210 which is a collection of the above-mentioned data is saved in the learning data storage unit 21.

Referring to FIG. 3B, the evaluation data storage unit 22 stores a plurality of pieces of individual evaluation data 220 as the evaluation data. Each pieces of individual evaluation data 220 includes input data 221, correct answer data 222, and a second category ID 223.

The input data 221 is the sensing data (the input data for the evaluation data) acquired by the forklift 3 for the evaluation data. The correct answer data 222 is correct answer data of the input data 221. The second category ID 223 is an identifier indicating the second category to which the individual evaluation data 220 belongs.

As illustrated in FIG. 1, the evaluation-data input data which becomes the input data 221 is input from the forklift 3 to the evaluation data acquisition unit 12. As explained with reference to FIG. 2, this input data 221 is transmitted to the teaching IF 6 and displayed; and as the user decides the correct answer data 222 and the second category ID 223 of the input data 221 with respect to this display, the correct answer data 222 and the second category ID 223 are input from the teaching IF 6 to the evaluation data acquisition unit 12. As a result, the evaluation data acquisition unit 12 can acquire the input data 221, the correct answer data 222, and the second category ID 223; and the individual evaluation data 220 which is a collection of the above-mentioned data is saved in the evaluation data storage unit 22.

Referring to FIG. 3C, the second category information storage unit 26 stores a plurality of pieces of the second category information 260, each of which is composed of a second category ID 261 and an operation coverage rate 262. The second category ID 261 corresponds to the second category ID 223 of the individual evaluation data 220 and its generation method is as described earlier. The operation coverage rate 262 is an index indicating an operation coverage rate for each second category of the evaluation data for the carrying work by the forklift 3 and is calculated based on operation frequency and operation conformity. The operation frequency: represents the frequency at which the carrying work by the forklift 3 is conducted; and can be determined in advance based on actual results of the carrying work in the past. Furthermore, the operation conformity represents a degree of desired smooth movements and can be determined by, for example, verifying the carrying work in the past.

Specifically speaking, for example, if the second categories are divided based on a combination of the camera image capturing object (a luggage rack or an autorator) and the image capture direction (from the left, from the center, or from the right) for the work of the forklift 3 to pick up the pallet, a total of six second categories are expected including three categories to pick up from the left, the center, or the right relative to an opening of the luggage rack and three categories to pick up from the left, the center, or the right relative the autorator. Under this circumstance, the operation coverage rate can be calculated by calculating a product obtained by multiplying the operation frequency by the operation conformity with respect to each second category and the obtained operation coverage rate is saved as the operation coverage rate 262. Incidentally, a method for calculating the operation coverage rate 262 is not limited to the simple product obtained by multiplying the operation frequency by the operation conformity as described above and other calculation methods such as weighting may be adopted. Furthermore, since the above-described operation coverage rate can be considered as one of indexes based on the operation frequency, for example, the operation frequency itself may be stored in the operation coverage rate 262 as a variation.

A supplementary explanation will be provided regarding a data structure of each storage unit other than those illustrated in FIG. 3A to FIG. 3C. The other sites' learning data storage unit 23 is a storage unit that stores the learning data at other sites; and the data structure of the stored learning data (individual learning data) may be considered similar to that of the individual learning data 210 of the learning data storage unit 21. Similarly, the other sites' evaluation data storage unit 24 is a storage unit that stores the evaluation data at other sites; and the data structure of the stored evaluation data (individual evaluation data) may be similar to that of the individual evaluation data 220 of the evaluation data storage unit 22. Furthermore, the other sites' estimation model storage unit 25 stores parameters for estimation models evaluated regarding the other sites; and in this embodiment, these parameters can be used as an initial value for the estimation model parameter calculation unit 14 that calculates parameters for estimation models at this site. By using the parameters for the estimation models at the other sites which are operated successfully as the initial value, it can be expected that the estimation model parameter calculation unit 14 will efficiently calculate the parameters for the estimation models at this site, while preventing calculation of an abnormal value.

Incidentally, in this embodiment, the word “site” means a place where the work of the forklift 3 is conducted; and classification into a plurality of sites in arbitrary units is possible. For example, the sites may be divided in warehouse units where the work is conducted, or the sites may be divided in floor units within the warehouse.

The detailed explanation will be provided below about a machine learning method and a forklift control method according to this embodiment by using the configuration illustrated in FIG. 1. Estimation model learning processing described below is executed by the machine learning apparatus 1 as the machine learning method according to this embodiment. Furthermore, forklift control processing described later is executed by the entire system illustrated in FIG. 1 as the forklift control method according to this embodiment.

### (2) Estimation Model Learning Processing

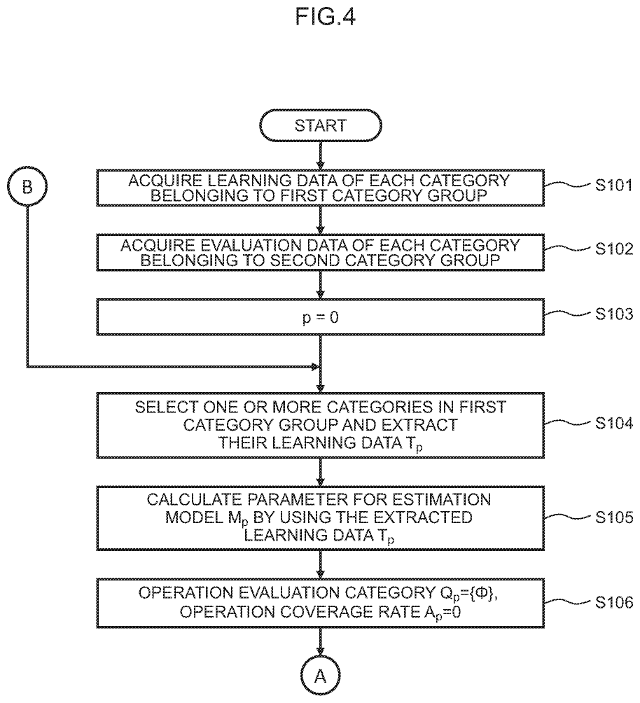

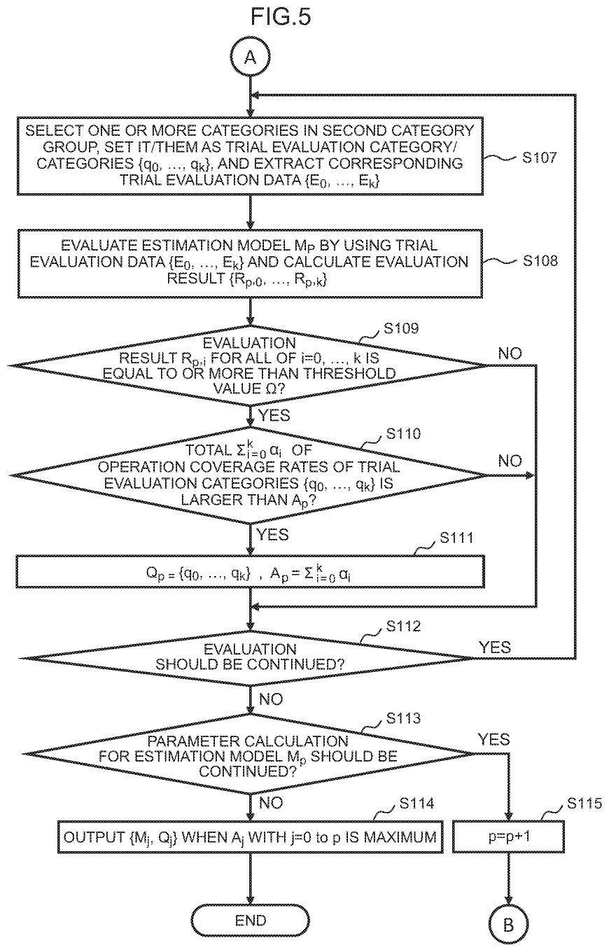

FIG. 4 and FIG. 5 are flowcharts (1 and 2) illustrating a processing sequence example of the estimation model learning processing. The estimation model learning processing illustrated in FIG. 4 and FIG. 5 is executed by each functional unit of the machine learning apparatus 1.

Referring to FIG. 4 and FIG. 5, the learning data acquisition unit 11 firstly acquires the learning data of each category belonging to the first category group (step S101). As explained earlier with reference to FIG. 2 and FIG. 3A to FIG. 3C, the learning data acquisition unit 11 acquires the input data 211, the correct answer data 212, and the first category ID 213 from the forklift 3 and the teaching IF 6 and saves the individual learning data 210, which is a collection of the above-mentioned data, in the learning data storage unit 21.

Next, the evaluation data acquisition unit 12 acquires the evaluation data of each category belonging to the second category group (step S102). As explained earlier with reference to FIG. 2 and FIG. 3A to FIG. 3C, the evaluation data acquisition unit 12 acquires the input data 221, the correct answer data 222, and the second category ID 223 from the forklift 3 and the teaching IF 6 and saves the individual evaluation data 220, which is a collection of the above-mentioned data, in the evaluation data storage unit 22.

Incidentally, in step S101 and S102, besides the data acquisition by the learning data acquisition unit 11 and the evaluation data acquisition unit 12, the learning data and the evaluation data can be created and acquired by simulation calculation by the simulator 18. In this case, the simulator 18: creates the learning data (individual learning data) or the evaluation data (individual evaluation data) by simulating the learning data and the evaluation data with respect to categories other than a category indicated by the operation category Q on the basis of the operation category Q which is output from the estimation model operational evaluation category output unit 17 described later: and saves the created data in the learning data storage unit 21 or the evaluation data storage unit 22. Accordingly, in this embodiment, the learning data and the evaluation data of each category can be acquired efficiently in relatively short time without depending solely on actual actions of the forklift 3 by making full use of the simulator 18.

Once the data of each category is saved in the learning data storage unit 21 and the evaluation data storage unit 22 by the processing in steps S101 and S102, processing in step S103 is executed.

In step S103, the trial learning data extraction unit 13 initializes variable p and sets 0 to it. Next, the trial learning data extraction unit 13 selects one or more first categories from the first category group of the learning data to select a category of the learning data which should be a trial object for a estimation model parameter calculation and extracts learning data Tₚ corresponding to the selected first category/categories from the learning data storage unit 21 (step S104). Incidentally, in step S103, the trial learning data extraction unit 13 may extract the learning data Tₚ from the other sites' learning data storage unit 23 in which the learning data at other sites is saved. For example, if the learning data of the selected first category is not stored (or acquired) in the learning data storage unit 21, it is possible to proceed with learning of estimation models with regard to the relevant first category by extracting the learning data Tₚ at another site which is similar to this site.

Next, the estimation model parameter calculation unit 14 calculates a parameter for an estimation model Mₚ by using the learning data Tₚ extracted in step S104 (step S105). A known method such as YOLO (You Only Look Once) may be used for the calculation of the parameter for the estimation model Mₚ by the estimation model parameter calculation unit 14.

Once the learning of the estimation model by the processing in steps S104 and S105 terminates, evaluation of this estimation model is started by using the evaluation data in step S106. Firstly, in step S106, for example, the estimation model operational evaluation category output unit 17 initializes Qₚ which represents the operation evaluation category and Aₚ which represents the operation coverage rate.

Then, the trial evaluation data extraction unit 15: selects one or more second categories from the second category group to select a category of the evaluation data which should be a trial object (trial evaluation category); and extracts the evaluation data corresponding to the selected second category/categories (trial evaluation data) from the evaluation data storage unit 22 (step S107). The trial evaluation category selected in step S107 is expressed as {q₀, . . . , qₖ} and the extracted trial evaluation data is expressed as {E₀, . . . , Eₖ}. Incidentally, in step S107, the trial evaluation data extraction unit 15 may extract the trial evaluation data from the other sites' evaluation data storage unit 24 in which the evaluation data at other sites are saved.

Next, the estimation model evaluation unit 16 evaluates the estimation model Mₚ, for which the parameter was calculated in step S105, by using the trial evaluation data {E₀, . . . , Eₖ} extracted in step S107 and calculates each evaluation result {R_{p,0}, . . . , R_{p,k}} (step S108). The estimation model evaluation unit 16 outputs the above-mentioned estimation model, the trial evaluation data, and the evaluation results to the estimation model operational evaluation category output unit 17.

Then, the estimation model operational evaluation category output unit 17 judges whether or not each of all the evaluation results calculated in step S108 is equal to or larger than a specified threshold value (Ω) (step S109). This threshold value: is a reference value for judging whether the evaluation result has achieved sufficient recognition accuracy for the actual operation or not; and is determined in advance. If an affirmative judgment result is obtained in step S109, it means that the evaluated estimation model Mₚ has the parameter which has achieved the sufficient recognition accuracy for the actual operation with respect to all the respective second categories corresponding to the trial evaluation data (the trial evaluation categories); and under this circumstance, processing in step S110 is executed. On the other hand, if a negative judgment result is obtained in step S109, the processing skips to step S112.

In step S110, the estimation model operational evaluation category output unit 17 calculates a total value of the operation coverage rates of the respective second categories included in the trial evaluation categories and judges whether this total value is larger than the current operation coverage rate Aₚ or not. If an affirmative judgment result is obtained in step S110, it means that the operation coverage rate of the current trial evaluation category by the estimation model Mp is the highest ever calculated; and under this circumstance, processing in step S111 is executed. On the other hand, if a negative judgment result is obtained step S110, the processing skips to step S112.

In step S111, the estimation model operational evaluation category output unit 17 updates the operation evaluation category Qₚ with the trial evaluation category {q₀, . . . , qₖ} selected in step S107 and updates the operation coverage rate Aₚ with the total value of the operation coverage rates calculated in step S110 (step S111). As a result of the processing in step S111, a combination of the second categories (which may also be read as operation scenes) which would make the operation coverage rate (an index based on the operation frequency) the highest ever evaluated if the estimation model Mₚ is used is recorded in the operation evaluation category Qₚ; and their operation coverage rate is recorded as the operation coverage rate Aₚ.

Then, in S112, whether or not the evaluation of the current estimation model Mₚ should be continued by changing the category of the evaluation data which should be the trial object (trial evaluation category) is checked. If the evaluation is continued by changing the trial evaluation category (YES in step S112), the processing returns to step S107 and the evaluation processing is repeated by selecting another trial evaluation category. Under this circumstance, since the operation evaluation category Qₚ (operation model Q in FIG. 1) is input from the estimation model operational evaluation category output unit 17 to the trial evaluation data extraction unit 15, the trial evaluation data extraction unit 15 can select one or more second categories from the second category group, from which the second categories included in the operation evaluation category Qₚ are excluded, in step S107 and can thereby extract the corresponding trial evaluation data. Accordingly, it is possible to search as many second categories of the second category group as possible for the operation evaluation category Qₚ by repeating the processing in steps S107 to S111, while feeding-back the operation evaluation category Q. On the other hand, if the evaluation of the current estimation model Mₚ is terminated (NO in step S112), the processing proceeds to step S113.

In step S113, whether the parameter calculation of the estimation model Mₚ should be continued or not, that is, whether or not the parameter calculation of the estimation model Mₚ should be continued by changing the category of the learning data which should be the trial object is checked. If the parameter calculation of the estimation model Mₚ is continued (YES in step S113), the value of the variable p is increased by one (step S114), then the processing returns to step S104, another one or more first categories are selected, and the learning processing is repeated. On the other hand, if the parameter calculation of the estimation model Mₚ is to be terminated (NO in step S113), the estimation model operational evaluation category output unit 17: outputs, as the estimation model M and the operation category Q, a combination of the estimation model Mⱼ and the operation evaluation category Qⱼ which make the operation coverage rate Aⱼ become maximum when repeating the processing in step S104 to S114 (j=0 to p), while changing the selection of the first category of the learning data for the parameter calculation of the estimation model and the selection of the second category of the evaluation data for evaluation of the estimation model (step S115); and terminates the estimation model learning processing.

Incidentally, the judgment in step S112 and step S113 may be made by the user or may be made by, for example, the estimation model operational evaluation category output unit 17 in accordance with specified rules. Examples of the specified rules include to continue the evaluation or the parameter calculation until all patterns are tried or until the number of trials reaches the defined number of times.

The machine learning apparatus 1 as described above prepares the learning data by dividing it into a plurality of first categories in the estimation model learning processing with respect to estimation models for controlling the forklift 3 (more specifically, for example, estimation models used to recognize the pallet from the sensing data), prepares the evaluation data by dividing it into a plurality of second categories on the basis of the operation scenes, learns the estimation models by using the learning data of the one or more selected first categories, evaluating the learned estimation models by using the evaluation data of the one or more selected second categories, and repeats such learning and evaluation, so that the evaluation result (recognition accuracy) can reach the accuracy required for the actual operation and a combination of the estimation model (the estimation model M) and its operation scene (the operation category Q) which would make the index based on the operation frequency (the operation coverage rate) become the highest can be decided.

Then, as the above-mentioned operation category Q is input, the manual steering IF 4 and the forklift operating management system 5 can instruct the forklift 3 to perform actions by recognizing the operation scenes where the actual operation is possible by using the estimation model M. Furthermore, as the above-mentioned estimation model M is input, the forklift 3 can estimate the specified object (pallet) with sufficient accuracy by image-analyzing the sensing data by using the estimation model M corresponding to the operation category Q (the second category) according to the operation scene. Therefore, the estimation model learning processing can define the operation scene (the operation category Q) to the maximum degree possible with the learning data in the current state; and based on this defined operation scene, the forklift 3 can actually operate at early timing while limiting the operation scene to the operation category Q.

Furthermore, the operation category Q decided by the estimation model learning processing is output from the estimation model operational evaluation category output unit 17 and also input to the simulator 18 (see FIG. 1). Having received the input of this operation category Q, the simulator 18 executes simulation of categories other than the category indicated by the operation category Q as described earlier and collects the learning data and the evaluation data. Consequently, in the estimation model learning processing executed subsequently, it is possible to promote the learning and evaluation of the estimation models so that the recognition accuracy which is the accuracy required for the actual operation can be also achieved with respect to the second categories (the operation scenes) which are not included in the operation category Q.

### (3) Forklift Control Processing

Some of the forklift control processing for controlling actions of the forklift 3 by making use of the result of the estimation model learning processing by the machine learning apparatus 1 will be explained below as a forklift control method according to this embodiment. Incidentally, the result of the estimation model learning processing which is required for each forklift control processing does not necessarily have to require the execution of all the processing sequences of the estimation model learning processing illustrated in FIG. 4 and FIG. 5.

### (3-1) First Forklift Control Processing

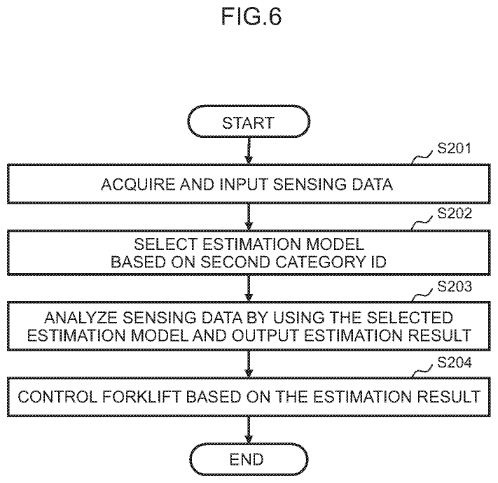

FIG. 6 is a flowchart illustrating a processing sequence example of first forklift control processing. The first forklift control processing illustrated in FIG. 6 is the most basic forklift control processing in this embodiment and is also commonly used in second to fourth forklift control processing described later.

Referring to FIG. 6, the forklift 3 which is in operation firstly acquires the sensing data by the sensor 31 and inputs the acquired sensing data (input data) to the data acquisition unit (the learning data acquisition unit 11 or the evaluation data acquisition unit 12) for the machine learning apparatus 1 according to the type of the input data (step S201).

Under this circumstance, a method for acquiring the input data in step S201 may vary depending on whether the forklift 3 is performing actions in accordance with a command of the manual steering IF 4 (upon manual steering) or in accordance with the autonomous work and action command of the forklift operating management system 5 (upon operation work).

In a case of the manual steering, the forklift 3 moves to a data acquisition place in accordance with a manual steering command. When the forklift 3 reaches the data acquisition place, the manual steering IF 4 issues an acquisition trigger to the forklift 3. Then, as triggered by the acquisition trigger, the forklift 3 acquires the sensing data (input data) by using the sensor 31 and inputs it to the data acquisition unit for the machine learning apparatus 1. Specifically speaking, the input data acquired for the learning data is input to the learning data acquisition unit 11 and the input data acquired for the evaluation data is input to the evaluation data acquisition unit 12. Incidentally, upon the manual steering, there is a possibility that it might be difficult to steer the forklift to an accurate position as compared to the actions in accordance with the autonomous work and action command. So, after arrival at the data acquisition place, the forklift 3 may continuously acquire the input data while being randomly minutely moved.

On the other hand, in a case of the operation work, while the forklift 3 is moving in accordance with the autonomous work and action command, it reaches a via-point having data acquisition information. Under this circumstance, the forklift 3 acquires the sensing data (input data) by the sensor 31 and inputs it to the data acquisition unit for the machine learning apparatus 1. Incidentally, upon the operation work, the input data may be acquired continuously before and after the via-point which is the data acquisition place.

When performing the operation work, the forklift operating management system 5 can decide what kind of autonomous work and action command should be given to the forklift 3, on the basis of the operation category Q output from the machine learning apparatus 1. Specifically speaking, for example, when the work to pick up a cargo (packet) from a certain luggage rack is to be implemented and if the operation category Q includes second category A “to capture images of the relevant luggage rack from the right side,” but does not include, for example, second category B “to capture images of the relevant luggage rack from the center” or second category C “to capture images of the relevant luggage rack from the left side,” the forklift operating management system 5 may issue the autonomous work and action command to the forklift 3 to approach to the luggage rack from the right side and pick up the packet according to the operation scene of the second category A.

Then, in the case of either the manual steering or the operation work as explained earlier with respect to the teaching IF 6, the input data which has been input to the data acquisition unit for the machine learning apparatus 1 is transmitted to the teaching IF 6 and displayed and the correct answer data and the category ID are added to it (see FIG. 2). Then, data which links the input data, the correct answer data, and the category ID together is saved as the individual learning data in the learning data storage unit 21 or the evaluation data storage unit 22.

Incidentally, in this embodiment, the work of an operation scene(s) which is adopted as the operation category Q by the estimation model learning processing may be assigned to a forklift 3 which is an unmanned forklift that can be instructed to be driven by the forklift operating management system 5 and the work of an operation scene(s) which is not adopted as the operation category Q by the estimation model learning processing (non-operation scene) may be assigned to a forklift 3 which can be steered remotely by the manual steering IF 4, or a manned forklift. By making such assignment, the forklift 3 can accept steering and operations (for example, teaching the position of the pallet) by the user at the non-operation scene(s) and implements the operation of the forklift 3 in accordance with the user's instructions.

Referring back to the explanation of FIG. 6, after the termination of step S201, the arithmetic operation unit 32 for the forklift 3 selects an estimation model based on the second category ID corresponding to the current operation scene by using the result of the estimation model learning processing by the machine learning apparatus 1 (step S202). Incidentally, the forklift 3 can recognize the second category ID corresponding to the current operation scene as such second category ID is directly designated by the manual steering IF 4 or included in the autonomous work and action command from the forklift operating management system 5.

Then, the arithmetic operation unit 32 analyzes the sensing data by using the estimation model selected in step S202 and outputs the estimation result obtained by the analysis (step S203). As a result of the processing in step S203, the specified object (for example, the pallet) is estimated with the recognition accuracy required for the actual operation.

Then, the control unit 33 for the forklift 3 controls actions of the forklift (for example, inserting the fork and moving it up and down) based on the estimation result of step S203 (step S204).

As the first forklift control processing is executed as described above, the forklift 3 can perform the actual operation for the work at the operation scene included in the operation category Q by estimating the specified object (for example, the pallet) from the sensing data with the recognition accuracy required for the actual operation.

Furthermore, regarding the first forklift control processing, when the acquisition trigger is issued from the manual steering IF 4 or when the data acquisition information is added to the via-point in the autonomous work and action command from the forklift operating management system 5, the sensing data (input data) can be collected during the actual operation of the forklift 3. Specifically, cargo carrying tasks are made feasible by making the forklift 3 actually operate and the acquisition of the input data which is actual data makes it possible to further collect the learning data and expand the operation scenes where the actual operation can be performed.

### (3-2) Second Forklift Control Processing

Second forklift control processing will be explained. The second forklift control processing is positioned as a variation of the first forklift control processing and the explanation will be mainly focused on the difference between them.

In the second forklift control processing, the manual steering IF 4 or the forklift operating management system 5 plans actions and work of the forklift 3 and causes the control unit 33 to control the forklift 3 based on that plan so that the input data of an operation scene(s) which was not adopted as the operation category Q (non-operation scene(s)) in the estimation model learning processing can be acquired during the work of the forklift 3.

Under this circumstance, the “non-operation scene(s)” is an operation scene(s) corresponding to a second category other than the second category (trial evaluation category) used for evaluation of the estimation model M having a parameter capable of estimating the evaluation result (recognition accuracy) which achieves the accuracy required for the actual operation in the estimation model learning processing. In other words, the “non-operation scene(s)” means an operation scene(s) corresponding to a second category which would not obtain the evaluation result (recognition accuracy) that achieves the accuracy required for the actual operation when the estimation model M is used.

More specifically, in the second forklift control processing, the manual steering IF 4 or the forklift operating management system 5: adjusts, for example, the position and posture of the forklift 3 and the fork so that the forklift 3 in operation can acquire the input data of the non-operation scene; and plans the actions and work of the forklift 3 to go through the state of being capable of acquiring the input data of the non-operation scene.

The second forklift control processing can make it possible to efficiently collect the input data of the non-operation scene as the forklift 3 in operation acquires the input data of the non-operation scene. Therefore, in the estimation model learning processing, it is possible to proceed with learning of the estimation model which can be used in the relevant non-operation scene and it is possible to contribute to promotion of the expansion of the operation scene where the actual operation can be performed, at early timing.

Regarding the above-described second forklift control processing, much higher advantageous effects can be expected particularly when the forklift 3 is at work in an operation scene included in the operation category Q in accordance with the autonomous work and action command by the forklift operating management system 5. A specific explanation will be provided by using the aforementioned second categories A, B, and C. When the work to pick up a cargo (packet) from a certain luggage rack is to be performed, and assuming that the operation category Q includes the second category A (to capture an image of the luggage rack from the right side) and the second categories B and C (to capture an image of the luggage rack from the center or the left side) are non-operation scenes, the forklift operating management system 5 issues an autonomous work and action command to approach to the relevant luggage rack from the right side and pick up the packet according to the operation scene of the second category A. Under this circumstance, in order to acquire the input data of the non-operation scene upon the operation work of the forklift 3 according to the operation scene of the second category A, the forklift operating management system 5 adds an autonomous work and action command, for example, to determine a via-point to move away from the luggage rack from the left side after approaching to the luggage rack from the right side and picking up the packet, and further set the data acquisition information to a specified via-point after moving away from the left side. By doing so, the forklift 3 can safely pick up the pallet by the work according to the operation scene (the second category A) included in the operation category Q and then acquire the input data of the non-operation scene (in this case, the second category C). Therefore, since it is possible to collect the input data of the non-operation scene while performing the actual operation of the operation scene limited by the operation category Q, it is possible to promote the learning and evaluation of the estimation model(s) every efficiently.

Incidentally, when executing the second forklift control processing, the input data of the non-operation scene can be acquired more efficiently by installing the pallet within the site and then deciding the operation category Q by the execution of the estimation model learning processing, and setting the non-operation scene.

Furthermore, since the second forklift control processing includes the first forklift control processing, the second forklift control processing can also obtain the advantageous effects by the first forklift control processing.

### (3-3) Third Forklift Control Processing

An explanation will be provided about third forklift control processing by comparing it with the first forklift control processing (FIG. 6) and mainly focusing on the difference between them.

In the third forklift control processing, the machine learning apparatus 1 firstly executes the estimation model learning processing and adopts the estimation model M, which is output as its finally determined result, as a first estimation model and the operation category Q as a first operation category (first operation scene).

Furthermore, the machine learning apparatus 1 sets second categories of non-operation scenes, which were not adopted as the first operation scene, as evaluation objects (trial evaluation categories) and executes the estimation model learning processing again; and if an estimation model which satisfies the evaluation result with the accuracy required for the actual operation (recognition accuracy) with respect to some second categories is obtained, the machine learning apparatus 1 adopts this estimation model as a second estimation model and its second category as a second operation category (second operation scene). The first and second estimation models are input to the forklift 3 and the first and second operation categories (the operation scenes) are input to the manual steering IF 4 and the forklift operating management system 5.

Then, when the forklift 3 performs actions in accordance with a command from the manual steering IF 4 or the forklift operating management system 5, the acquisition and input of the sensing data are firstly performed at the forklift 3 (in a manner similar to step S201 in FIG. 6).

Next, the arithmetic operation unit 32 selects an estimation model based on the second category ID corresponding to the current operation scene. Specifically, if an operation scene indicated with the second category ID is the first operation scene, the arithmetic operation unit 32 selects the first estimation model; and if an operation scene indicated with the second category ID is the second operation scene, the arithmetic operation unit 32 selects the second estimation model. Incidentally, it is assumed in a manner similar to the first forklift control processing that the second category ID corresponding to the current operation scene is directly designated by the manual steering IF 4 or is included in the autonomous work and action command from the forklift operating management system 5.

Then, the arithmetic operation unit 32 analyzes the sensing data by using the estimation model selected in step S202 and outputs the estimation result obtained by the analysis (in a manner similar to step S203 in FIG. 6).

Then, the control unit 33 for the forklift 3 controls the actions (for example, inserting the fork and moving it up and down) based on the estimation result of step S203 (in a manner similar to step S204 in FIG. 6).

As a result of the third forklift control processing described above, the specified object (for example, the pallet) can be estimated with the recognition accuracy which is the accuracy required for the actual operation by using the plurality of estimation models whichever suited according to the operation scenes of the forklift 3, so that it is possible to expand the range of the operation scenes where the actual operation can be conducted.

Furthermore, since the third forklift control processing includes the first forklift control processing, the third forklift control processing can also obtain the advantageous effects by the first forklift control processing.

### (3-4) Fourth Forklift Control Processing

Fourth forklift control processing will be explained. The fourth forklift control processing is control processing suited for a case where an operation scene of the forklift 3 occurs randomly, in other words, a case where the operation scene is unclear.

In the fourth forklift control processing, a plurality of estimation models which satisfy the evaluation result with the accuracy required for the actual operation (recognition accuracy) with respect to one or more second categories (operation scenes) are firstly learned by the estimation model learning processing. Furthermore, regarding each of these estimation models, a recognition success rate (evaluation result) regarding the estimation of each operation scene (second category) is calculated. The above-mentioned plurality of estimation models, the second categories (actually, the second category ID's), and the evaluation results of the respective estimations are output to the forklift 3. Then, when operating the forklift 3 under the circumstance where the operation scene is unclear, the arithmetic operation unit 32 for the forklift 3: calculates a total estimation result (for example, an average value) which is the estimation result as a whole, from the estimation results (individual estimation results) of an object (for example, the position of the pallet) estimated from the input data by using each of the plurality of the estimation models; and finds a success rate (success or failure information) of the estimation by each estimation model from the total estimation result and the individual estimation results. Furthermore, the arithmetic operation unit 32: calculates validity of each estimation result based on the evaluation result of each estimation model, which was retained earlier, with respect to each of the plurality of operation scenes (second categories); and evaluates the validity of the estimation result as a whole (total estimation result) as a collection of the above-mentioned respective estimation results. Then, if an evaluation value of the operation scene (second category) with the highest validity among the validity of the total estimation result with respect to each of the above-mentioned second categories is equal to or larger than a specified threshold value, the control unit 33 for the forklift 3 controls the actions of the forklift 3 on the basis of that total estimation result.

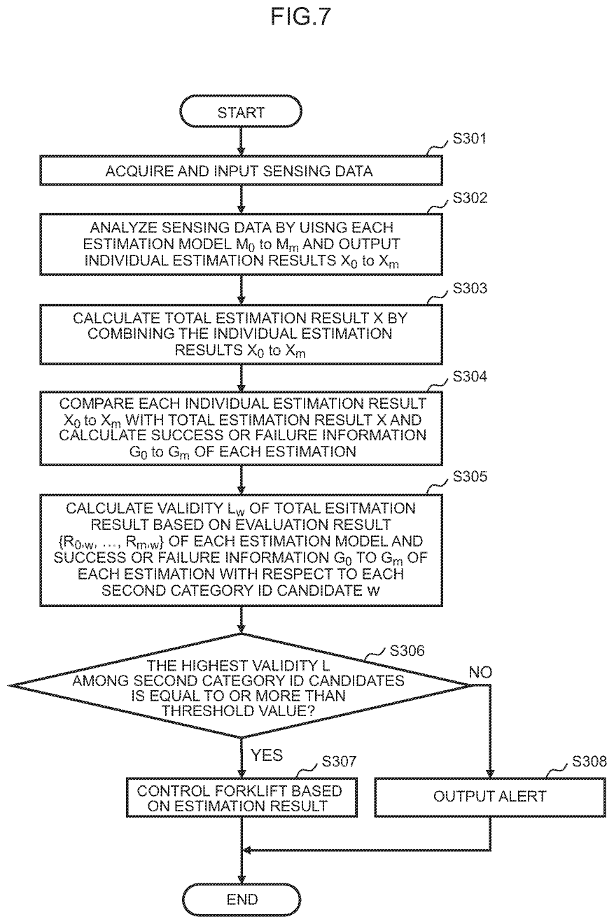

FIG. 7 is a flowchart illustrating a processing sequence example of the fourth forklift control processing. With the fourth forklift control processing illustrated in FIG. 7, it is assumed that the forklift 3 is in operation under the circumstance where the operation scene (the second category) has not been decided (or cannot be decided). Furthermore, terms described with variables in each step in FIG. 7 correspond to terms described in the previous paragraph.

Referring to FIG. 7, the forklift 3: firstly acquires the sensing data by the sensor 31 while performing actions; and inputs the acquired sensing data (input data) to the data acquisition unit for the machine learning apparatus 1 (the learning data acquisition unit 11 or the evaluation data acquisition unit 12) depending on the type of the input data (step S301).

Next, the arithmetic operation unit 32 for the forklift 3: analyzes the sensing data (input data) by using m pieces of estimation models (M₀ to Mₘ) respectively which have been learned by the estimation model learning processing and can be used for the actual operation; and outputs the obtained individual estimation results (X₀ to Xₘ) (step S302).

Next, the arithmetic operation unit 32 calculates a total estimation result X by combining the individual estimation results (X₀ to Xₘ) obtained in step S302 together (step S303). For example, if an average value of the individual estimation result (X₀ to Xₘ) is the total estimation result X, the total estimation result X can be calculated according to Expression 1 below.

$$\begin{matrix}[ Math . 1 ] & \\ X = \frac{{X}_{0} + … + {X}_{m}}{m + 1} & ( Expression 1 )\end{matrix}$$

Next, the arithmetic operation unit 32 compares each of the individual estimation results (X₀ to Xₘ) with the total estimation result X calculated in step S303, thereby calculating estimation success or failure information (G₀ to Gₘ) which represents a success rate of the estimation result (X₀ to Xₘ) by each estimation model (M₀ to Mₘ) (step S304). For example, if the estimation result by the estimation model is indicated with a rectangular area in a manner similar to the correct answer data illustrated in FIG. 2, the success or failure information (G₀ to Gₘ) of each estimation can be calculated according to Expression 2 below.

$$\begin{matrix}[ Math . 2 ] & \\ {G}_{0} ∼ {G}_{m} = \frac{Overlap Area}{Total Area} & ( Expression 2 )\end{matrix}$$

In Expression 2, the total area means the area (square measure) of the rectangular area indicated by the total estimation result X. Furthermore, the overlap area means the area (square measure) of an overlapped region with the rectangular area indicated by the individual estimation result (Xᵢ) which is an object compared with the rectangular area indicated by the total estimation result X.

Incidentally, the calculation method of Expression 2 is one example; and besides this method, for example, an overlapping rate (overlap rate) of the rectangular area indicated by the individual estimation result (Xᵢ) which is the object compared with the rectangular area indicated by the total estimation result X may be calculated; and if this overlapping rate (overlap rate) is equal to or larger than a specified threshold value, the success or failure information may be found as Gᵢ=1; and if this overlapping rate (overlap rate) is smaller than the specified threshold value, the success or failure information may be found as, for example, Gᵢ=0.

Subsequently, by using the evaluation result R of each estimation model which is retained in advance with respect to each of the second categories (a candidate w for the second category ID) corresponding to the estimation models (M₀ to Mₘ), and the success or failure information (G₀ to Gₘ) of each estimation calculated in step S304, the arithmetic operation unit 32 calculates validity L_{w} of the estimation result as a whole (total estimation result) with respect to the candidate w for the second category ID (step S305). Incidentally, in step S305, the validity L_{w} of the total estimation result is calculated by changing the candidate w for the second category ID and targeting all the second categories corresponding to the estimation models (M₀ to Mₘ).

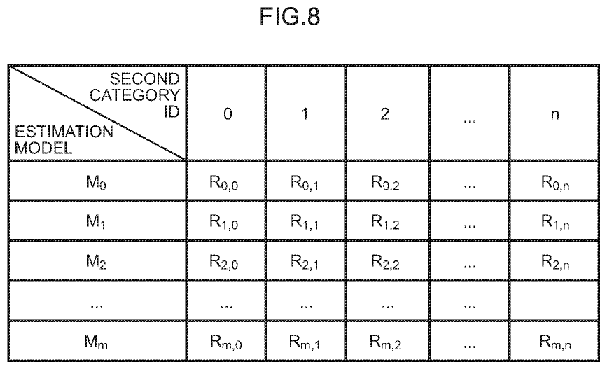

FIG. 8 is a diagram for explaining the relationship between the estimation models and the second category ID's with respect to the evaluation result R of the estimation models. As illustrated in FIG. 8, the evaluation result R of the estimation models is configured by the evaluation results of all combinations of the estimation models (M₀ to Mₘ) and the second category ID's (0 to n) of the second categories corresponding to the estimation models (M₀ to Mₘ), that is, m×(n+1) pieces of the evaluation results. The evaluation result {R_{0,w}, . . . , R_{m,w}} of the estimation models indicated in FIG. 8 is expressed by a determinant of Expression 3 below.

$$\begin{matrix}[ Math . 3 ] & \\ Evaluation Result = [ \begin{matrix}{R}_{0 , 0} & … & {R}_{0 , n} \\ ⋮ & ⋱ & ⋮ \\ {R}_{m , 0} & … & {R}_{m , n}\end{matrix} ] & ( Expression 3 )\end{matrix}$$

Then, when using the evaluation result {R_{0,w}, . . . , R_{m,w}} of the above-described estimation model, the validity L_{w} of the total estimation result with respect to the second category ID candidate w can be calculated according to, for example, Expression 4 below. Incidentally, the second category ID candidate w is, for example, included in the autonomous work and action command from the forklift operating management system 5 and input to the forklift 3.

$$\begin{matrix}[ Math . 4 ] & \\ {L}_{w} = \frac{{\sum }_{m = 0}^{m} \{ {R}_{i , w} * {G}_{i} + ( 1 - {R}_{i , w} ) ( 1 - {G}_{i} ) \}}{m + 1} & ( Expression 4 )\end{matrix}$$

Next, the arithmetic operation unit 32 judges whether the highest validity L among the validity L_{w} of the total estimation result calculated for each of all the second category ID candidates w in step S305 is equal to or larger than a specified threshold value or not (step S306). This threshold value: is a reference value for judging whether or not the total estimation result which has obtained the validity L achieves sufficient recognition accuracy (evaluation result) for the actual operation; and may be, for example, the same as the threshold value Ω indicated in step S109 in the estimation model learning processing in FIG. 5.

In step S306, if the validity L is equal to or larger than the specified threshold value (YES in step S306), it means that the total estimation result which has obtained the validity L has sufficient recognition accuracy for the actual operation. Therefore, the arithmetic operation unit 32 estimates the second category indicated by the second category ID candidate w regarding the total estimation result, which has obtained the validity L, as the current operation scene. Then, the control unit 33 controls the actions of the forklift 3 on the basis of the operation scene (the second category) estimated by the arithmetic operation unit 32 (step S307).

On the other hand, if the validity L is smaller than the specified threshold value in step S306 (NO in step S306), it means that the total estimation result L_{w} regarding any second category ID candidate w does not have sufficient recognition accuracy for the actual operation. Therefore, the arithmetic operation unit 32 outputs an alert to the effect that the operation scene cannot be estimated (step S308). When the alert is output, the control unit 33, for example, stops autonomous driving of the forklift 3, transfers the alert to the forklift operating management system 5, and secures safety for the operation work.

According to the fourth forklift control processing described above, even if the current operation scene is unclear for the forklift 3 in operation, a combination of the estimation model, by which the recognition accuracy enabling the actual operation can be secured, and the operation scene (the second category) can be estimated by using the known estimation model M, regarding which the parameter enabling the actual operation has been calculated by the learning result of the estimation model learning processing, and its operation category Q (the second category ID) and evaluating the validity of the estimation result by the above-mentioned combination, and the forklift 3 can be operated based on this estimation result.

Therefore, with the fourth forklift control processing, not only it can be expected to start the operation of the forklift 3 at a point in time when the collected learning data is much smaller, but also the forklift 3 can be operated in a wider range of operation scenes than that of the first to third forklift control processing when the learning data has been accumulated.

Furthermore, since the fourth forklift control processing includes the first forklift control processing, the fourth forklift control processing can also obtain the advantageous effects by the first forklift control processing.

One embodiment of the present invention has been described above; however, the present invention is not limited to the aforementioned embodiment, and includes various variations. For example, the aforementioned embodiment has been described in detail in order to explain the invention in an easily comprehensible manner and is not necessarily limited to the embodiment having all the configurations explained above. Furthermore, the configuration of another embodiment can be added to, deleted from, or replaced with part of the configuration of the embodiment. Furthermore, in the above-described embodiment, the explanation has been provided about the machine learning method for learning the estimation models for recognizing the pallet from the sensing data with regard to the forklift for carrying the pallet loaded with a cargo and about the forklift control method for controlling actions of the forklift by using such estimation models; however, targets to apply the present invention are not limited to them and the present invention can be applied generally to, for example, vehicles and apparatuses, other than the forklift, for executing specified work. Furthermore, the estimation models which are learned by the machine learning method of the present invention can be also applied to estimation models for recognizing an object other than the pallet and estimation models for judging control such as vehicle behavior prediction.

Furthermore, each of the aforementioned configurations, functions, processing units, processing means, etc. may be implemented by hardware by, for example, designing part or all of such configurations, functions, processing units, and processing means by using integrated circuits or the like. Moreover, each of the aforementioned configurations, functions, etc. may be implemented by software by processors interpreting and executing programs for realizing each of the functions. Information such as programs, tables, and files for realizing each of the functions may be retained in memories, storage devices such as hard disks and SSDs (Solid State Drives), or storage media such as IC cards, SD cards, and DVDs.

Furthermore, control lines and information lines which are considered to be necessary for the explanation are illustrated in the drawings; however, not all control lines or information lines are necessarily indicated in terms of products. Practically, it may be assumed that almost all components are connected to each other.

### REFERENCE SIGNS LIST

1: machine learning apparatus 1
3: forklift
4: manual steering IF
5: forklift operating management system
6: teaching IF
11: learning data acquisition unit
12: evaluation data acquisition unit
13: trial learning data extraction unit
14: estimation model parameter calculation unit
15: trial evaluation data extraction unit
16: estimation model evaluation unit
17: estimation model operational evaluation category output unit
18: simulator
21: learning data storage unit
22: evaluation data storage unit
23: other sites' learning data storage unit
24: other sites' evaluation data storage unit
25: other sites' estimation model storage unit
26: second category information storage unit
31: sensor
32: arithmetic operation unit
33: control unit
210: individual learning data
211: input data
212: correct answer data
213: first category ID
220: individual evaluation data
221: input data
222: correct answer data
223: second category ID
260: second category information
261: second category ID
262: operation coverage rate

1. A machine learning method for learning estimation models for controlling a forklift, the machine learning method executing:
step 1 of accepting input of learning data of a first category group and evaluation data of a second category group;
step 2 of extracting the learning data of at least one category from the first category group and calculating parameters of the estimation models for controlling the forklift by using the extracted learning data;
step 3 of extracting the evaluation data of at least one category from the second category group and evaluating the estimation models, for which the parameters are calculated in the step 2, by using the extracted evaluation data; and
step 4 of outputting the estimation models, each of which has an evaluation result of the step 3 that is equal to or larger than a specified threshold value, from among the estimation models for which the parameters are calculated in the step 2, and a category of the evaluation data used for the evaluation of each above-mentioned estimation model in the step 3.

2. The machine learning method according to claim 1, further executing:
step 5 of extracting one of the estimation models output in the step 4 as a first estimation model; and
step 6 of extracting a second estimation model used for evaluation of the evaluation data of a category other than the category of the evaluation data used for evaluation of the first estimation model from among the estimation models output in the step 4.

3. The machine learning method according to claim 1, further executing:
step 5 of extracting one of the estimation models output in the step 4 as a first estimation model; and
step 7 of creating, by a simulator, learning data of a category other than the category of the evaluation data used for evaluation of the first estimation model.

4. The machine learning method according to claim 2,
wherein in the step 5, the first estimation model is extracted based on operation frequency of the category of the evaluation data output in the step 4.

5. The machine learning method according to claim 3,
wherein in the step 5, the first estimation model is extracted based on operation frequency of the category of the evaluation data output in the step 4.

6. A forklift control method for executing:
an input step of accepting input of sensing data by a sensor installed at a forklift;
an estimation step of analyzing the sensing data accepted in the input step by using a first estimation model obtained by executing the following step 1 to step 5, and outputting an estimation result obtained by the analysis;
step 1 of accepting input of learning data of a first category group and evaluation data of a second category group;
step 2 of extracting the learning data of at least one category from the first category group and calculating parameters of estimation models for controlling the forklift by using the extracted learning data;
step 3 of extracting the evaluation data of at least one category from the second category group and evaluating the estimation models, for which the parameters are calculated in the step 2, by using the extracted evaluation data;
step 4 of outputting the estimation models, each of which has an evaluation result of the step 3 that is equal to or larger than a specified threshold value, from among the estimation models for which the parameters are calculated in the step 2, and a category of the evaluation data used for the evaluation of each above-mentioned estimation model in the step 3; and
step 5 of extracting the first estimation model from among the estimation models output in the step 4 on the basis of operation frequency of the category of the evaluation data output in the step 4; and
a control step of controlling the forklift on the basis of a result of the estimation step.

7. The forklift control method according to claim 6,
wherein in the control step, the forklift is controlled to collect the learning data of a category other than the category of the evaluation data used for evaluation of the first estimation model extracted in the step 5.

8. The forklift control method according to claim 6,
wherein in the control step, when controlling the forklift in a scene other than an operation scene corresponding to the category of the evaluation data used for evaluation of the first estimation model extracted in the step 5, the forklift accepts input by a user.

9. The forklift control method according to claim 6,
wherein in the estimation step, the forklift control method further executes step 6 of extracting a second estimation model used for evaluation of the evaluation data of a category other than the category of the evaluation data used for evaluation of the first estimation model from among the estimation models output in the step 4; and
wherein the sensing data accepted in the input step is analyzed by using the first estimation model extracted in the step 5 and the second estimation model extracted in the step 6 whichever suited according to a category corresponding to an operation scene of the forklift, and an estimation result obtained by the analysis is output.

10. The forklift control method according to claim 6,
wherein in the control step,
the sensing data is analyzed by using each of the plurality of estimation models obtained by executing the step 4;
a total estimation result is calculated from individual estimation results obtained by the analysis;
success or failure information of an estimation by each estimation model is calculated by comparing the individual estimation results with the total estimation result;
validity of the evaluation data with respect to the total estimation result is calculated for each category of the second category group on the basis of the calculated success or failure information of the estimation and an evaluation result of evaluation by using the evaluation data of the second category group with respect to each of the plurality of estimation models; and
when the validity of a category regarding which the calculated validity is the highest among the evaluation data of the second category group is equal to or larger than a specified threshold value, the forklift is controlled based on the total estimation result of the above-mentioned category.

11. A machine learning apparatus for learning estimation models for controlling a forklift, the machine learning apparatus comprising:
a data acquisition unit that accepts input of learning data of a first category group and evaluation data of a second category group;
a parameter calculation unit that extracts the learning data of at least one category from the first category group and calculates parameters of the estimation models for controlling the forklift by using the extracted learning data;
an estimation model evaluation unit that extracts the evaluation data of at least one category from the second category group and evaluates the estimation models, for which the parameters are calculated by the parameter calculation unit, by using the extracted evaluation data; and
an estimation model operational evaluation category output unit that outputs the estimation models, each of which has an evaluation result by the estimation models evaluation unit that is equal to or larger than a specified threshold value, from among the estimation models for which the parameters are calculated by the parameter calculation unit, and a category of the evaluation data used for the evaluation of each above-mentioned estimation model by the estimation model evaluation unit.
